(19) United States
(12) Patent Application Publication
(10) Pub. No.: US 2012/0123956 A1
(43) Pub. Date: May 17, 2012

(54) SYSTEMS AND METHODS FOR MATCHING CANDIDATES WITH POSITIONS BASED ON HISTORICAL ASSIGNMENT DATA

(75) Inventors: Vijil Enara Chenthamarakshan, Kerala (IN); Nandakishore Kambhatla, Bangalore (IN); Rose Catherine Kanjiranthinkal, Kerala (IN); Amit Kumar Rambachan Singh, Mumbai (IN); Karthik Visweswariah, Bangalore (IN)

(73) Assignee: INTERNATIONAL BUSINESS MACHINES CORPORATION, Armonk, NY (US)

(21) Appl. No.: 12/944,868

(22) Filed: Nov. 12, 2010

(51) Int. Cl. G06Q 10/00

(52) U.S. Cl. 705/321

(57) ABSTRACT

Systems and associated methods for matching candidates with positions through an automated scoring and ranking process utilizing a scoring function based on previous assignments. The ranking of candidates includes identifying the position requirements, mining relevant candidate information, prioritizing mined information based upon past assignments, and ranking candidates based on how well they match the position requirements. The systems and methods are applicable for use in different environments, including online job portals, recruiting services, and by company human resource departments.

### BACKGROUND

Hiring the right talent is a challenge faced by all companies. This challenge is often amplified by a high volume of applicants, especially if the business is labor intensive, growing or faces high attrition rates. Companies often receive thousands of resumes for each job posting and employ dedicated screeners to short list qualified applicants. In addition, companies face similar issues when assigning current employees to work on internal projects and assignments. Given the importance of matching people with jobs and projects, a method to efficiently and accurately handle candidate information, job requirements and identify matches is highly desirable.

### BRIEF SUMMARY

Systems and associated methods for matching candidates with positions through an automated scoring and ranking process are described. Systems and methods provide for matching candidates with positions by ranking candidates utilizing a scoring function based on previous assignments. Embodiments provide for the ranking of candidates which includes identifying the position requirements, mining relevant candidate information, prioritizing mined information based upon past assignments, and ranking candidates based on how well they match the position requirements.

In summary, one aspect provides a system comprising: at least one processor; and a memory operatively connected to the at least one processor; wherein, responsive to execution of computer readable program code accessible to the at least one processor, the at least one processor is configured to: access historical position assignment data; extract at least one candidate attribute from candidate data; access at least one position feature from at least one position; and rank at least one candidate profile based on the at least one position feature, the at least one candidate attribute, and the historical position assignment data.

Another aspect provides a method comprising: accessing historical position assignment data; extracting at least one candidate attribute from candidate data; accessing at least one position feature from at least one position; and ranking at least one candidate profile based on the at least one position feature, the at least one candidate attribute, and the historical position assignment data.

A further aspect provides a computer program product for a computer readable storage medium having computer readable program code embodied therewith, the computer readable program code comprising: a computer readable storage medium having computer readable program code embodied therewith, the computer readable program code comprising: computer readable program code configured to access historical position assignment data; computer readable program code configured to extract at least one candidate attribute from candidate data; computer readable program code configured to access at least one position feature from at least one position; and computer readable program code configured to rank at least one candidate profile based on the at least one position feature, the at least one candidate attribute, and the historical position assignment data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of a typical recruitment process with manual screening.

FIG. 2 illustrates an example of a typical hiring process utilizing current automated matching methods.

FIG. 3 illustrates a method for providing a ranked list of candidates.

FIG. 4 illustrates a method for providing a ranked list of candidates.

FIG. 5 illustrates an example of extracting candidate information from a candidate's application materials.

FIG. 6 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid obfuscation.

The description now turns to the figures. The illustrated example embodiments will be best understood by reference to the figures. The following description is intended only by way of example and simply illustrates certain example embodiments representative of the invention, as claimed.

Matching people with jobs and assignments is an important problem. Currently, there are many existing methods aimed at addressing this problem, including online job portals, recruitment services and traditional hiring methods involving the manual processing of each candidate.

As a non-limiting example, an Information Technology (IT) services business in a growth market serves as an illustration of the challenges facing companies looking to find candidates for positions or assignments. In a typical services organization, professionals with varied technical skills and business domain expertise are hired and assigned to projects to solve customer problems. In the past few years, IT services including consulting, software development, technical support and the like have witnessed explosive growth, especially in growth markets like India and China. For organizations in the IT services business, growth in business is synonymous with growth in the number of employees and recruitment is a key function. Hiring large numbers of IT professionals in growth markets poses unique challenges. Most countries in growth markets have large populations of qualified technical people who all aspire to be part of the explosive growth in the IT Services industries. Thus, a job posting for a Java programmer can easily attract many tens of thousands of applications in a few weeks. Most IT services companies are inundated with hundreds of thousands of applicants.

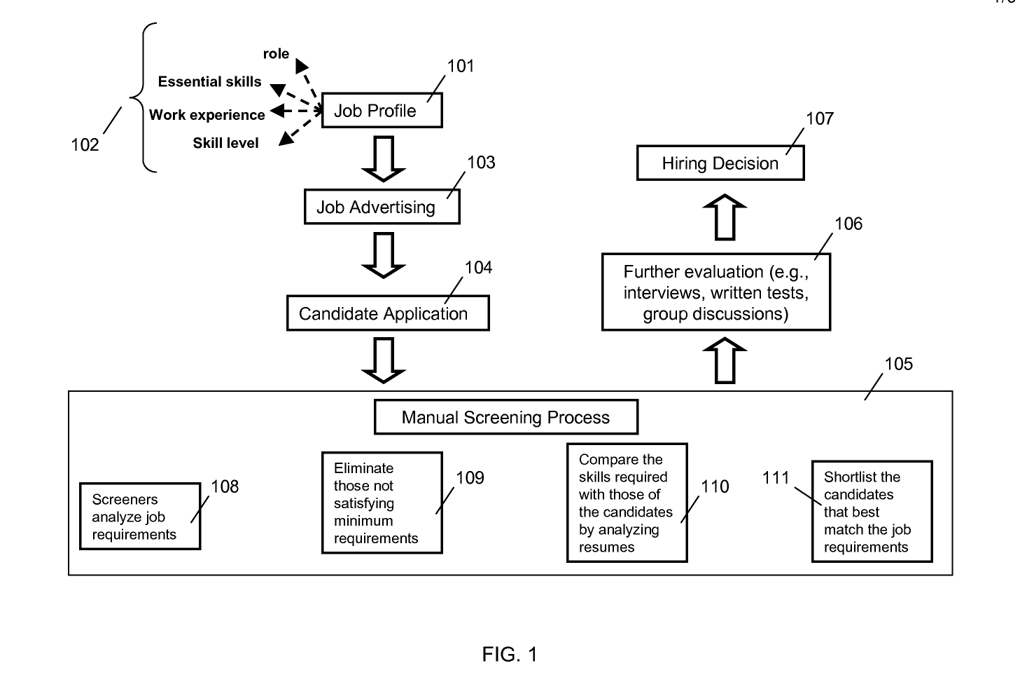

Referring to FIG. 1, therein is depicted a typical recruitment process with manual screening that may be utilized by an employer, such as an IT services company. Generally, the process starts when a business unit decides to hire employees to meet its business objectives or assign personnel to a project. The business unit creates a job profile 101 that describes the position and its requirements 102. As a non-limiting example, such a description may include the role, job category, essential skills, location, the nature of work, work experience, and skill level required. The job opening may then be advertised 103 through multiple channels, including online job portals and newspaper advertisements. Interested candidates then apply for the job 104. For example, candidates may apply by uploading a profile through a designated website, emailing a resume, or contacting a hiring agency 104.

Once the applications of prospective candidates are received, they enter a manual screening process 105. During this screening process, the information submitted by the candidates 104 is subjected to careful scrutiny by a set of dedicated screeners. This screening process is crucial because it directly affects the quality of the intake and hence, the company profits. The screeners analyze the job requirements 108 in order to understand the requirement for the job opening. Such requirements include the skills that are mandatory and those that are optional but preferable, experience criteria, or preference for the location of the candidate. This analysis is performed in view of the kind of work that will be performed as part of the job role. The screeners then look through each of the applications, and reject those who do not have the minimum years of experience or the skills required for the job 109. The next step typically requires the screener to read the remaining resumes in detail and compare them with the job profile 110. A shortlist of candidates that best match the job requirements is then derived from the resume analysis 111.

Since the number of candidates who can be interviewed is limited, the screener has to make a relative judgment on the candidates. In addition, the top few candidates who are shortlisted during the screening may undergo further evaluation 106, which may be in the form of interviews, written tests, or group discussions. The screening process and any further evaluation processes may then be used to make any final hiring decisions 107.

Several issues arise during a typical manual screening process, such as the process depicted in FIG. 1. For example, filtering out the top candidates from a large pool of applicants is a very time consuming and expensive endeavor. In addition, the quality of any such filtering process is variable and highly dependent upon the particular personnel performing the task. As such, there is not an adequate method to quantify candidate decisions because of their highly subjective nature. Furthermore, a candidate's profile is multifaceted and often the various attributes in his profile are not directly comparable with others. For example, a first candidate may be highly experienced in the technical area but may not have the desired industry domain expertise. A second candidate may have the required domain expertise, but may be slightly less experienced in the technical area than the first candidate. In addition, a third candidate might be much more versatile, possessing skills in a large number of technical areas and business domains, but lacking the required mastery of a specific technical area. The screener has to go through the resume of each applicant and quickly decide whether to shortlist the candidate or not. Ideally, the screener should not make this decision without looking at the resumes of other candidates who have applied for the job. If the screener defers the decision, it is difficult to later come back and make a decision, especially when there are thousands of candidates who have applied for the same job. Also, the screeners are typically under immense pressure to hire people quickly, since the rapid growth of labor intensive companies is critically dependent on a rapid response to hiring needs. Often, because of these time pressures, screeners rely on a small sample of interested candidates or a ranking provided by third party hiring firms to screen and shortlist candidates. In some cases, a screener might not have even looked at the application materials for the best candidate for a job.

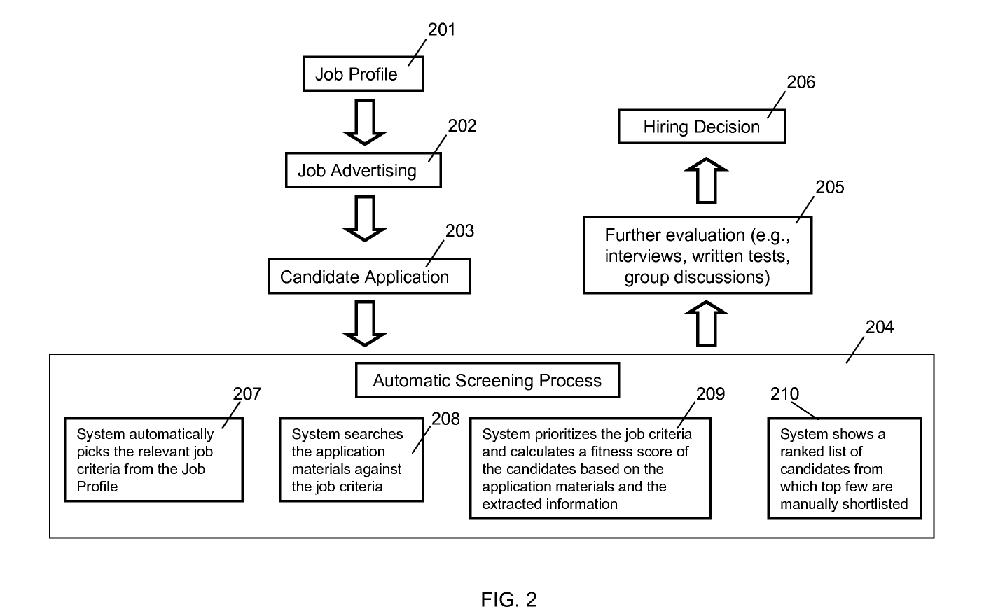

Referring to FIG. 2, therein is depicted a typical hiring process utilizing current automated matching methods. The process starts when a business unit decides to hire employees to meet its business objectives or assign personnel to a project. The business unit creates a job profile 201 that describes the position and its requirements. The job opening may then be advertised 202 and interested candidates subsequently apply for the job 203. Once the applications of prospective candidates are received, they enter an automated screening process 204. During this screening process, relevant job criteria are specified 207 by the system automatically picking the relevant job criteria from the job profile 201. These criteria essentially act as keywords and are used during a keyword search 208 of the candidate application materials against the job criteria. The keywords may be weighted to further match position requirements to candidates 209. For example, the system may prioritize the job criteria and calculate a candidate fitness score based on the application materials and the extracted information. Such weighting 209, or prioritizing, may be based on human knowledge of keyword importance, ad hoc weights for different dimensions such as resume score or industry sector match, or through statistical weighting schemes such as term frequency-inverse document frequency (TF-IDF). Candidates are then ranked 210 based on the results of the automated keyword search, from which a few top candidates are manually shortlisted. Decisions for further evaluation 205 or hiring decisions 206 are made based upon the ranked list 210.

Although the process for matching candidates with positions depicted in FIG. 2 appears to be more efficient than the manual matching scheme illustrated in FIG. 1, shortcomings still exist in meeting the needs of today's employers. For example, it is difficult to manually come up with a position requirement weighting scheme. In addition, such weighting schemes may not include important aspects of a candidate profile, such as the number of years of candidate experience, certifications, past projects, and employment history. A typical automated matching process, such as that illustrated in FIG. 2, does not adequately look at all of the different factors, nor does it look at the factors in relation to each other. Instead, such processes merely match up keywords in a candidate's application materials with those in the position description. As a result, current automated matching processes are not very accurate. Even if the process takes all of the relevant position requirements into account, it does not handle how the different requirements are related. For example, current automated matching processes may not be able to adequately rank a candidate with an advanced degree and little experience in relation to a candidate with a lesser degree but with significantly more experience. In this scenario, the candidate with the lesser degree may not be considered if an advanced degree was specified because the advanced degree did not show up in the search of the candidate's application materials. However, the business organization may have had success in the past when hiring more experienced candidates with lesser degrees. As such, according to this method, this particular candidate would not be considered although he may have been a good match for the position.

According to embodiments, more accurate and useful candidate ranking is realized through integrating past assignment data into the automated candidate scoring system. Embodiments utilize the past assignment data to mimic past manual matching of candidates to positions.

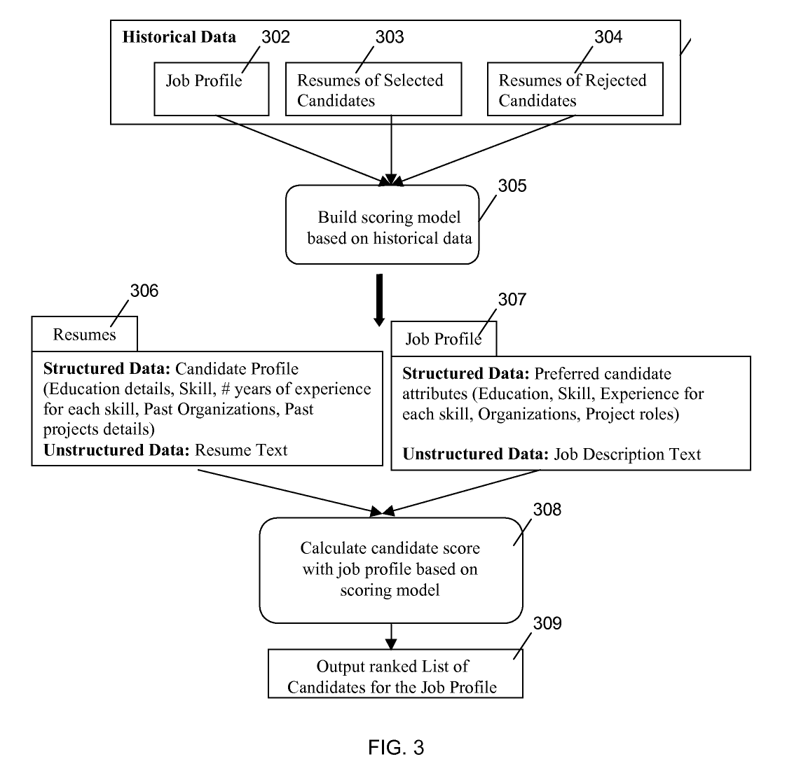

Referring now to FIG. 3, therein is depicted a high-level illustrative embodiment. Historical data 301 is compiled, including, but not limited to, past assignments 302 and rejections of candidates 303 for particular job profiles 301. The historical data is used to create a scoring model 305. The illustrative embodiment then provides that candidate information 306 is analyzed in relation to the job profile 307 and a candidate score is calculated 308 with the job profile based upon the scoring model 305. After the candidate scores have been calculated 308, a ranked list of candidates for the particular job profile is created 309.

According to embodiments, the historical data may be assembled from past job description information and candidate application materials. Embodiments provide that the historical data may be stored in a database format. As non-limiting examples, a business unit may create a database of past job assignments, or a recruiter may create a database of skill data. The past job assignment database may include, but is not limited to, job description, assigned candidates, and rejected candidates records. Embodiments analyze the historical data by using the previous candidate assignments as positive examples and the rejected candidates as negative examples. The positive and negative examples need to be balanced because for each position there will most likely be a much larger number of negative examples compared to positive examples.

Substitutable skills may also be modeled according to embodiments. As a non-limiting example, a candidate attribute, such as skill set or industry sector, may not be an exact match for a particular position requirement but may serve as an adequate match nonetheless. According to embodiments, the candidate attribute may be substituted for a position requirement if historical data indicates that the attribute and the requirement are interchangeable or closely related such that the candidate's attribute may be substituted for the requirement. As a non-limiting example, an opening may require skills typical of an employee from the banking sector, but a candidate only has insurance sector experience. Embodiments provide that if historical data or positive examples indicate that insurance sector experience is substitutable for banking sector experience, then the candidate may be able to fulfill the position requirements with minimal training

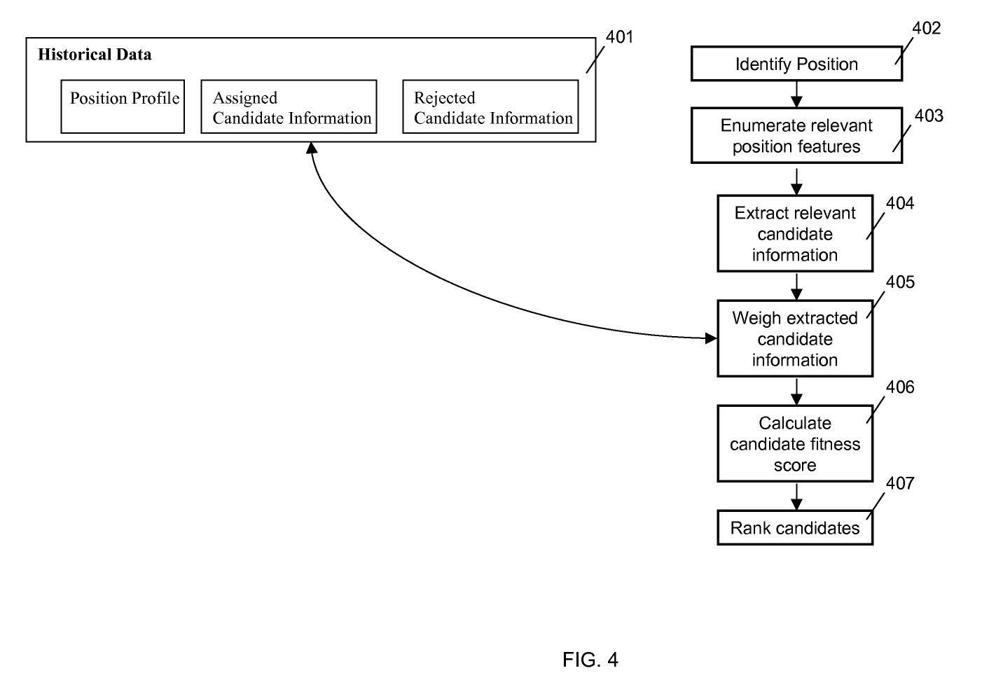

Referring to FIG. 4, therein is depicted another embodiment. Historical data 401 is collected, including, but not limited to past position profiles, assigned candidates, and rejected candidates information. A position is identified 402 and the relevant position features are enumerated 403. As a non-limiting example, relevant position features may include educational level, educational institution, sector experience, past organization, length of experience, foreign language skills, skill set, number of years of experience in each skill, resume score, and employer information. Relevant candidate information is then extracted 404 and weighted 405. Embodiments provide that in addition to, or in conjunction with, other methods, the relevant candidate information may be weighted 405 according to the historical data 401. A fitness score for each candidate is calculated 406 and the candidates are ranked according to this score 407. According to embodiments, the fitness score indicates how well a particular candidate matches the position.

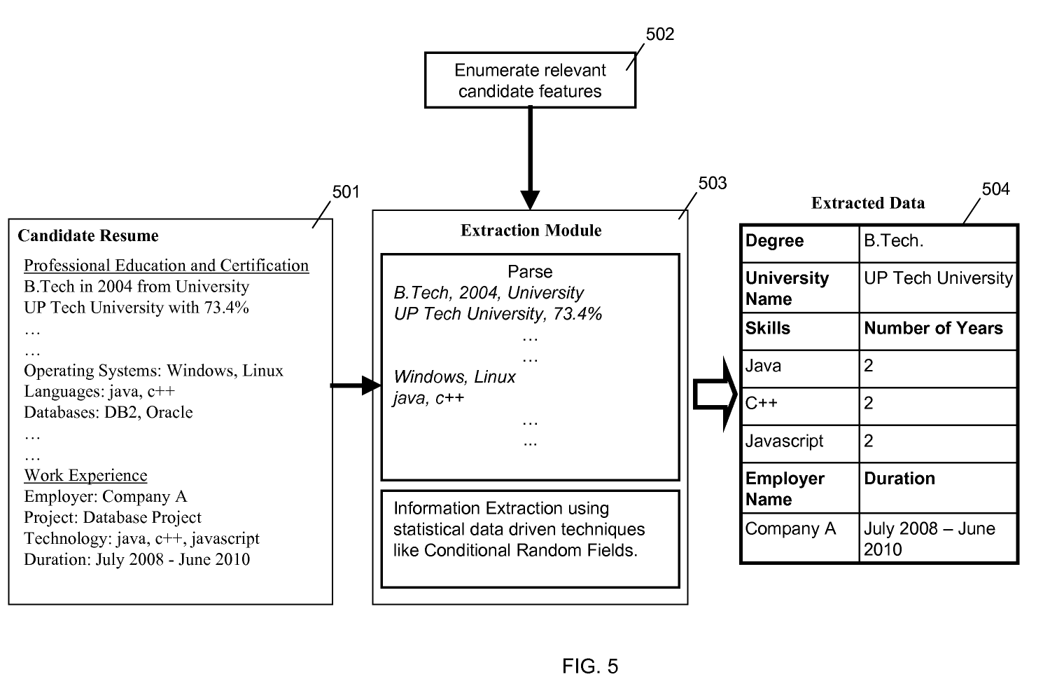

Referring now to FIG. 5, therein is depicted a general overview of extracting candidate information from a candidate's application materials. In this illustration, the candidate's application materials consist of a resume 501 in an electronic format. Relevant candidate features are specified 502. An extraction module 503 parses the resume 501 and extracts the relevant candidate features within the resume 501. Such extracted features are now available in a structured format 504.

Embodiments may be utilized in different applications. Examples include, but are not limited to, online job portals, recruiting services, and by companies themselves. For each application, embodiments provide that a fitness score between a candidate and a position is needed. In addition, other applications concern the type of candidate and the type of position involved. Examples include, but are not limited to, hiring a new candidate for an open position, and assigning an existing employee or contractor to a project. According to embodiments, the historical data utilized to prioritize any enumerated position features should be consistent with the type of candidates and positions involved. As a non-limiting illustration, if the subject application involves hiring a new employee for an open position, then the historical data should be directed toward a matching or similar application, and not, for example, the assignment of a contractor to an unrelated project.

As described earlier, current candidate placement methods do not adequately and efficiently prioritize position features and candidate attributes. Embodiments provide for a method for learning the priorities of relevant features, including, but not limited to, position features and candidate attributes. Embodiments learn the priorities utilizing historical position assignment data to mimic what was important in the past. As such, a non-limiting example of a system according to an embodiment may involve utilizing the assignment data to learn and model what human resources personnel found important when assigning candidates to a position in the past. Another non-limiting example involves learning from the historical data that in similar past assignments the number of years of experience with a particular technology had priority over level of degree.

Embodiments provide methods for learning a position assignment scoring function to mimic past assignments of people to jobs. As such, embodiments may be set up as a classification or ranking problem. Classification and ranking may be based on methods, including, but not limited to, a logistic regression classifier. In addition, embodiments use previous assignments as positive examples and the remaining as negative examples. In most situations the number of positive examples will be substantially less than the number of negative examples. Thus, the positive and negative examples will need to be balanced out. Furthermore, embodiments provide for the implicit modeling of substitutable skills.

According to embodiments, past assignments and historical assignment data may be utilized as training data. As a non-limiting example, this training data may be used to learn the preferences of humans in assigning jobs to people. In addition, embodiments employ as features various structured attributes mined from candidate application information, including, but not limited to, candidate resumes. The original form of the extracted data may have been in a structured or unstructured form. Furthermore, embodiments learn a model that, given the features and the past assignments as labeled training data, may be utilized to produce a ranked list of candidates. As such, embodiments take a machine learning approach to solve an important business problem of matching candidates to positions by explicitly modeling past assignment behavior.

A non-limiting example test case involving an embodiment will serve to demonstrate some benefits of the described approach. In this test case, each job used fairly loose constraints to get a set of feasible candidates. On average, there were approximately 2300 candidates per position. The available data was divided into training and test data. A scoring function was built on the training data and the test data was evaluated according to embodiments. In addition, a logistic regression classifier was used in the test case. Utilizing a resume scoring system, the mean rank of an assigned candidate was 700 and the fraction of assigned candidates that were in the top 30 was 13%. However, for the learned function according to embodiments, the mean rank of an assigned candidate was 225 and the fraction of assigned candidates in the top 30 was 31%. As such, the test case demonstrates, among other things, a marked improvement in identifying and assigning higher ranked candidates into positions.

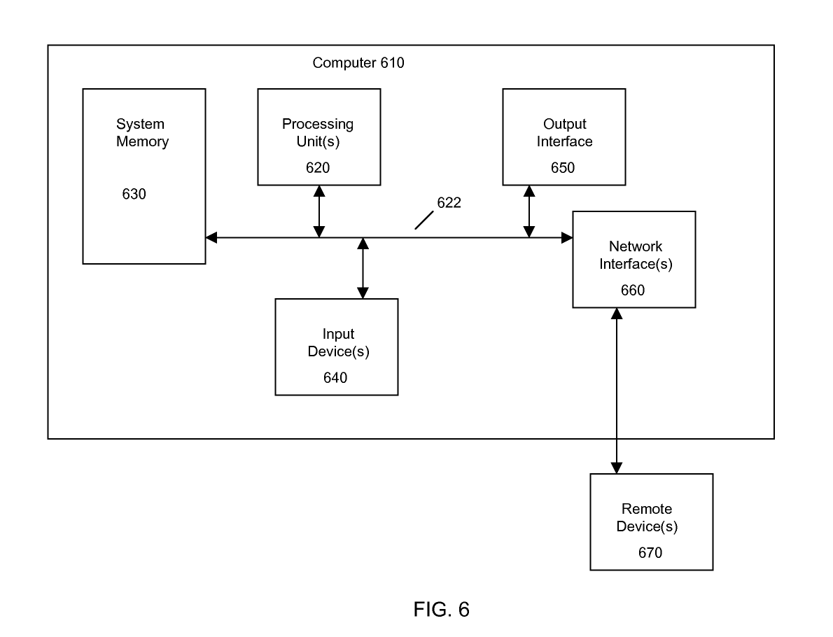

Referring to FIG. 6, it will be readily understood that certain embodiments can be implemented using any of a wide variety of devices or combinations of devices. An example device that may be used in implementing one or more embodiments includes a computing device in the form of a computer 610. In this regard, the computer 610 may execute program instructions configured to create a historical database, extract candidate information, enumerate relevant position features, rank candidates according to fitness score, and perform other functionality of the embodiments, as described herein.

Components of computer 610 may include, but are not limited to, a processing unit 620, a system memory 630, and a system bus 622 that couples various system components including the system memory 630 to the processing unit 620. The computer 610 may include or have access to a variety of computer readable media. The system memory 630 may include computer readable storage media in the form of volatile and/or nonvolatile memory such as read only memory (ROM) and/or random access memory (RAM). By way of example, and not limitation, system memory 630 may also include an operating system, application programs, other program modules, and program data.

A user can interface with (for example, enter commands and information) the computer 610 through input devices 640. A monitor or other type of device can also be connected to the system bus 622 via an interface, such as an output interface 650. In addition to a monitor, computers may also include other peripheral output devices. The computer 610 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
at least one processor; and
a memory operatively connected to the at least one processor;
wherein, responsive to execution of computer readable program code accessible to the at least one processor, the at least one processor is configured to:
access historical position assignment data;
obtain at least one candidate attribute from candidate data;
access at least one position feature from at least one position; and
rank at least one candidate profile based on the at least one position feature, the at least one candidate attribute, and the historical position assignment data.

2. The system according to claim 1, wherein the historical position assignment data are selected from the group consisting of: past position profiles, assigned candidate information, and rejected candidate information.

3. The system according to claim 2, wherein the assigned candidate information is utilized as positive assignment examples and the rejected candidate information is utilized as negative assignment examples.

4. The system according to claim 1, wherein the at least one position feature is selected from the group consisting of: educational level, educational institution, industry sector, sector experience, length of experience, skill set, number of years in each skill, and employer information.

5. The system according to claim 1, further comprising:
generating extracted attributes for each of the at least one candidate profile by extracting at least one candidate attribute relevant to the at least one position feature; and
weighting the extracted attributes according to the historical position assignment data.

6. The system according to claim 5, further comprising:
calculating a fitness score for each at least one candidate profile based on the extracted attributes and the at least one position feature.

7. The system according to claim 1, further comprising:
assigning a fitness score to the at least one position.

8. The system according to claim 1, further comprising:
at least one attribute substitution, the at least one attribute substitution serving as a substitute for at least one candidate attribute.

9. The system according to claim 1, further comprising:
learning manual assignment preferences applied in at least one previous manual position assignment based on the historical position assignment data;
ranking the at least one candidate based on the manual assignment preferences.

10. The system according to claim 1, wherein the at least one position is provided by the group consisting of: an online job portal, a recruitment service, or a business.

11. A method comprising:
accessing historical position assignment data;
obtaining at least one candidate attribute from candidate data;
accessing at least one position feature from at least one position; and
ranking at least one candidate profile based on the at least one position feature, the at least one candidate attribute, and the historical position assignment data.

12. The method according to claim 11, wherein the historical position assignment data are selected from the group consisting of: past position profiles, assigned candidate information, and rejected candidate information.

13. The method according to claim 12, wherein the assigned candidate information is utilized as positive assignment examples and the rejected candidate information is utilized as negative assignment examples.

14. The method according to claim 11, wherein the at least one position feature is selected from the group consisting of: educational level, educational institution, industry sector, sector experience, length of experience, skill set, number of years in each skill, and employer information.

15. The method according to claim 11, further comprising:
generating extracted attributes for each of the at least one candidate profile by extracting at least one candidate attribute relevant to the at least one position feature; and weighting the extracted attributes according to the historical position assignment data.

16. The method according to claim 15, further comprising:
calculating a fitness score for each at least one candidate profile based on the extracted attributes and the at least one position feature.

17. The method according to claim 11, further comprising:
assigning a fitness score to the at least one position.

18. The method according to claim 11, further comprising:
at least one attribute substitution, the at least one attribute substitution serving as a substitute for at least one candidate attribute.

19. The method according to claim 11, further comprising:
learning manual assignment preferences applied in at least one previous manual position assignment based on the historical position assignment data;
ranking the at least one candidate based on the manual assignment preferences.

20. A computer program product comprising:
a computer readable storage medium having computer readable program code embodied therewith, the computer readable program code comprising:
computer readable program code configured to access historical position assignment data;
computer readable program code configured to extract at least one candidate attribute from candidate data;
computer readable program code configured to access at least one position feature from at least one position; and
computer readable program code configured to rank at least one candidate profile based on the at least one position feature, the at least one candidate attribute, and the historical position assignment data.
